(19) United States
(12) Patent Application Publication
(10) Pub. No.: US 2006/0034303 A1
(43) Pub. Date: Feb. 16, 2006

(54) System and method for managing transactions related to messages transmitted in a communication network

(75) Inventors: Teemu Ikonen, Espoo (FI); Juha Koponen, Helsinki (FI)

Correspondence Address: YOUNG & THOMPSON, 745 SOUTH 23RD STREET, 2ND FLOOR, ARLINGTON, VA, 22202, US

(73) Assignee: FIRST HOP LTD., HELSINKI (FI)

(21) Appl. No.: 11/219,750

(22) Filed: Sep. 7, 2005

Related U.S. Application Data
(63) Continuation of application No. PCT/FI04/50023, filed on Mar. 3, 2004.

(30) Foreign Application Priority Data
Mar. 7, 2003 (FI) 20030346

(51) Int. Cl. H04L 12/56

(52) U.S. Cl. 370/401

(57) ABSTRACT

A system can be located in a communication network in which it handles several simultaneous sessions and transmits messages between end nodes. The system identifies a type of transaction belonging to a session. The transaction type identified is mapped to a token that belongs to an input alphabet of an automaton. The system inputs the said token into the automaton that is preferably a deterministic finite-state automaton. According to a response of the automaton, the system performs a set of predefined tasks. Those tasks may concern analysing the use of a service, charging of an end-user, etc.

### FIELD OF THE INVENTION

The present invention generally relates to services and enhanced possibilities to deploy a service and after that to control, adjust, charge, and report the use of the service.

### BACKGROUND OF THE INVENTION

Service management requires the implementation of a number of various communication methods between network operators and service providers. A service provider may need to use different communication methods with different network operators. A communication method includes more than message routing and an application protocol, such as wireless application protocol (WAP). Using a router, such as the First Hop message router manufactured by the applicant, can solve the drawback of different communication methods. A router provides so called messaging connectivity.

Internet-based services use, for example, the following protocols: IP, TCP, UDP, or Hyper Text Transfer Protocol (HTTP). Messaging-based services available today mainly use short message service (SMS), enhanced messaging service (EMS), or multimedia messaging service (MMS) messages to reach end-users.

FIG. 1 shows a controlled service management provided by a router. There are three service providers, one service operator, two network operators, and a set of terminals. The router 101 of the service operator transmits messages between the services and the network operators, such as a service 102 and a network operator 103. For example, the service 102 can communicate with the SMS centres of both the network operators 103 and 104 via the router. The service 102 does not need to know SMS center-specific details; it just needs to know one communication method that it uses with the message router. Thus, the message router implements the messaging connectivity enabling services to communicate with different types of SMS centres and other operator systems.

The applicant's two previously filed patent applications are notably related to the background of the invention.

FI20011813 generally relates to messaging services. It teaches that messages should be classified to control, adjust, and report the use of a service in an economic way. The classification of messages is based on some characteristics of messages, for example, on sender, length, date, time, or price information of messages. The classification may also be based on the content of the message, which can be traced by comparing matching words or bit patterns. The classification affects which processing rules are obeyed. For example, the said message is: 1) rejected or deleted, 2) altered, or 3) directed to other media than the original receiver, 4) saved to a data-base, 5) responded to with certain logic or 6) left untouched and transmitted to the receiver. The patent application FI20011813 teaches how to classify messages and map each classified message to a certain processing rule and then handle the classified messages according to the processing rules.

PCT/FI02/00270 deals with the controlling and managing aspects of messaging services. It describes a messaging manager that provides user interfaces and tools for making message classifications of. The classifications and predefined task specifications are stored in a profile database. The messaging manager also provides a common mechanism for authorizing and supporting the use of messaging services. The mechanism is based on the use of the profile database.

FIG. 2 shows the said mechanism. A user 201 sends a message 202 via the messaging manager 203 to the service. The sent message 202 includes a piece of information that is a search key 204. The messaging manager obtains the search key 204 from the message 202 and accesses a profile 205 from a profiles database 206 by using the search key. After that, the messaging manager performs a task defined in the accessed profile 205. In this example the task is such that the messaging manager sends an input message 207 with certain content to the service 208.

Both patent applications FI20011813 and PCT/FI02/00270 relate to messaging services, but some of their teachings can be also utilized in a system where a service operator hosts several Internet service providers.

The first drawback is that there is a lack of detailed and reliable statistics concerning the use and operation of services. For this reason, the business reporting facilities are poor, which increases the business risks of service providers.

The second drawback is that the processes and tools for allowing service providers to test and deploy Internet services are incomplete in the system where a service operator hosts several Internet service providers.

The third drawback is that there is a lack of tools for controlling and supporting the use of services.

To summarize, the co-operation of service operators and service providers could be arranged in a better way than in the prior art.

In addition to the above-mentioned drawbacks there is a drawback related to billing. Many end-users experience that the billing based on the amount of traffic in GPRS, WAP, and other packet-based communication is unfair. When a communication link is slow, for one reason or other, there are a lot of retransmission requests and the quality of service is disappointing. However, the retransmitted packets cause that billing is higher compared to a case where the communication link operates normally. The billing systems of service operators are made for bulk transmission, i.e. the used capacity is always billed. The billing systems could charge end-users taking into account whether the communication was successful or not.

### SUMMARY OF THE INVENTION

The main objective of the invention is to solve the above-mentioned drawbacks of the prior art. In order to reach this, a session of a communication network should be considered as a set of transactions, each transaction of the said set having a certain transaction type.

A system accordant with the invention manages transactions and performs predefined tasks mapped to the said transactions.

The system is adapted to operate as follows. First, it identifies a transaction's type. The transaction is related to at least one message transmitted in a communication network during a session. The transaction type identified is mapped to a token belonging to an input alphabet of an automaton. Secondly, the system inputs the token into the automaton. Thirdly, the system performs a set of predefined tasks according to the response of the automaton. The predefined tasks may concern analysing the use of a service, charging of an end-user, etc.

The system is termed a transaction manager, because it identifies transactions. The system described in PCT/FI02/00270 is termed a messaging manager, because it identifies messages, especially short messages. Both systems can provide versatile management possibilities for users through their user interfaces.

The first important aspect in the transaction manager is that it is able to identify a transaction type. The transaction manager is typically located in a communication network in which it handles several simultaneous sessions and transmits messages between end nodes.

The second, even more important aspect is that the transaction manager inputs a token, which corresponds to the type of the transaction identified, into an automaton. The automaton concept is very powerful in this context. By means of it the transaction manager can recognize transactions composed of messages, as well as transaction sets composed of the recognized transactions.

The transaction manager can be utilized, for example, in node handling HTTP sessions. A successful HTTP session contains the following transactions: 1) a client opens a TCP connection to a server, 2) the client sends a service request to the server, 3) the server sends a response to the client, and 4) the client closes the TCP connection. In a successful HTTP session, transaction 3 should follow transaction 2. The transaction manager may verify this and report, if transaction 3 does not follow transaction 2. Reporting is just one example of a predefined task performed by the transaction manager. If needed, a special type of transaction can be added to messages. This way the transactions related to the messages can be classified very precisely.

The transaction manager may be placed in a server which is owned by a service provider and which provides a service. Alternatively, the transaction manager may be placed in a server owned by a service operator. The said server can be connected to a message router providing messaging connectivity between the service providers and the network operators. In other words, the message router hides possible differences in communication methods when a service of a service provider communicates with equipment of the network operators.

In addition to the transaction manager, the invention comprises the method used in the transaction manager.

### BRIEF DESCRIPTION OF THE DRAWINGS

The invention is described more closely with reference to the accompanying drawings, in which

FIG. 1 shows a message router routing messages between services and network operators,

FIG. 2 shows a transaction manager authorizing and supporting the use of messaging services,

FIG. 3 shows automaton M_{HTTP} as a transition graph,

FIG. 4 shows the main steps of the method,

FIG. 5 shows automaton M_{A} as a transition graph,

FIG. 6 shows the operation table related to the automaton M_{A},

FIG. 7 shows an example of the transaction manager connected to a message router.

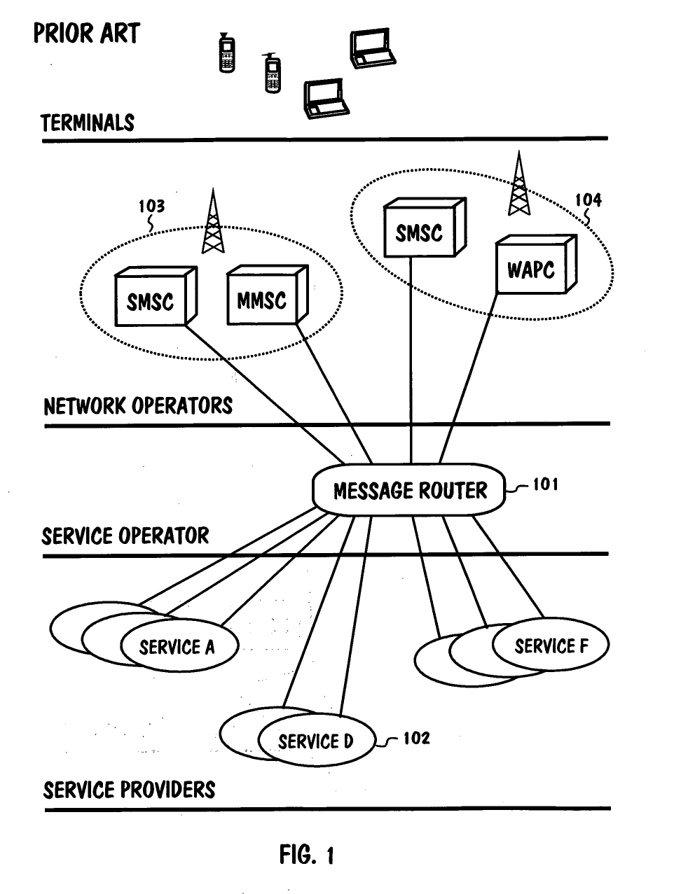

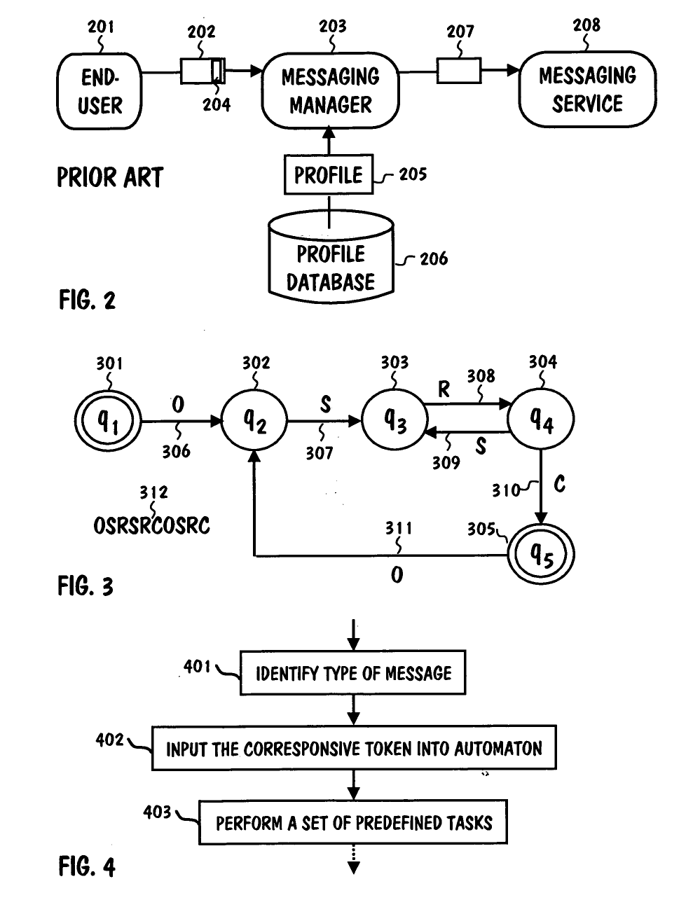

### DETAILED DESCRIPTION OF THE INVENTION

In this patent application a basic assumption is that a session of a communication network is composed of at least one connection and each connection is composed of at least one transaction, and each transaction is composed of at least one message. It should be noticed that those messages are not necessarily of the same type. Messages may include search keys as in PCT/FI02/00270 and the transaction manager may use them in the same way as the messaging manager. A search key may indicate a transaction type. However, the transaction manager can identify transactions without any search key. The transaction manager performs or initiates tasks on the basis of the identified transactions. The operation of the transaction manager is greatly based on computing theory, especially automatons. Therefore the automaton concept and some other concepts are shortly discussed.

A regular expression is a character string, which is composed of the characters of a certain alphabet so that the regular expression includes 1) consecutive characters and/or 2) alternative characters, and/or 3) repetitive characters. For example, an alphabet ‘A’ may consist of characters ‘b’ and ‘c’. This is marked A={b, c}. Let us assume that a regular expression is composed of the characters of the alphabet A. The said regular expression may include consecutive characters, such as “bc”, alternative characters, i.e. ‘b’ or ‘c’, and/or repetitive characters, such as “bbbb” which is marked (b)*.

Recognition means that a character string is recognized by using a rule set. For example, a single rule could be: “Is a character string accordant with a regular expression?” Let us say that the character string is “bc” and the regular expression is “bc”. Then the character string is accordant with the regular expression. Actually, no other character string is. Parsing differs from the recognition in that parsing concerns the structure composed of character strings. The character strings may, for example, be words of a spoken language. For example, in an English sentence “Billy a boy is” all the character strings “Billy”, “a boy”, and “is” are correct words, but parsing results in that the word order of the sentence is incorrect accordant with English grammar.

A so-called finite automaton comprises: 1) a state alphabet, 2) an input alphabet, 3) a rule set, 4) an initial state, and 5) a set of final states. If the rules of the rules set are such that in every state of an automaton it is possible to follow only one rule, the automaton is deterministic. There are many types of automatons described in the prior art. The space complexity of a deterministic finite-state automaton is constant, which simplifies the making of programs. Therefore the said automaton type is much used in computer programs and we concentrate on its description.

A deterministic finite-state automaton accepts a character string, if the character string is accordant with a certain regular expression. Otherwise, it rejects the character string. For example, an automaton ‘M’ could comprise three states, which are marked q₁, q₂, and q₃, and two rules, which are marked q₁b→q₂ and q₂c→q₃. The rule q₁b→q₂ is termed “a transition on b from the state q₁ to the state q₂”, and the rule q₂c→q₃ is termed “a transition on c from the state q₂ to the state q₃”. Let us assume that the state q₁ is an initial state and the state q₃ is a final state. Then the automaton M is marked as follows:
M=({q₁, q₂, q₃}, {b, c}, {q₁b→q₂, q₂c→q₃}, q₁, {q₃}),

wherein the set {q₁, q₂, q₃} is the state alphabet, the set {b, c} is the input alphabet, the set {q₁b→q₂, q₂c→q₃} is the rule set, the state q₁ is the initial state, and the set {q₃} comprises the final states. The operation of the automaton M is very simple. It accepts only the character string “bc” and rejects all other character strings.

To show how a deterministic finite-state automaton can be utilized in connection with HTTP sessions, we define an alphabet A_{HTTP}. We may map characters to the HTTP transaction types, for example, as follows:

a transaction type in which a client opens a TCP connection to a server is mapped to the character O.

a transaction type in which the client sends a service request to the server is mapped to the character S.

a transaction type in which the server sends a response to the client is mapped to the character R.

a transaction type in which the client closes the TCP connection is mapped to the character C.

The alphabet A_{HTTP} is composed of characters O, S, R, and C, i.e.
A_{HTTP}={O, S, R, C}.

As mentioned above, in a successful HTTP session a client opens a TCP connection, sends one or more service requests to a server, obtains one or more responses, and closes the TCP connection. Then the client may open a new connection within the HTTP session, etc. A successful HTTP session can be defined more precisely by writing a regular expression E_{HTTP}:
E_{HTTP}=(O(SR)*C)*

which is composed of the characters of the alphabet A_{HTTP}.

A deterministic finite-state automaton M_{HTTP} that recognizes the regular expression E_{HTTP} is defined as follows:
M_{HTTP}=(Q, A_{HTTP}, P, q₁, {q₃}),

wherein the state alphabet Q={q₁, q₂, q₃, q₄, q₅}, A_{HTTP} is the input alphabet, the rule set P={q₁O→q₂, q₂S→q₃, q₃R→q₄, q₄C→q₅, q₄S→q₃, q₅O→q₂}, q₁ is the initial state, and {q₃} is the set of final states.

FIG. 3 shows the automaton M_{HTTP} as a transition graph. There are five states 301-305 and six transitions 306-311. The automaton M_{HTTP} reads and examines a character string “OSRSRCOSRC” 312 one character at a time. The first character of the string 312 is ‘O’. Then the automaton M_{HTTP} can use the rule q₁O→q₂, thus it performs a transition 306 on O from the state q₁ 301 to the state q₂ 302. The second character of the string 312 is ‘S’, thus the automation M_{HTTP} uses the rule q₂S→q₃. The third character is ‘R’ and the automaton M_{HTTP} uses the rule q₃R→q₄. The automaton M_{HTTP} is in the state q₄ 304 and the fourth character of the string 312 is ‘S’. The automaton M_{HTTP} performs a transition 309 to the state q₃ 303 on the basis of the rule q₄S→q₃. The seventh character of the string 312 is again ‘O’. This means that the HTTP session related to the character string 312 contains another connection. Now, the automaton M_{HTTP} performs a transition 311 to the state q₂ 302. When the automaton M_{HTTP} has handled the ninth character, the current state is q₄ 304. The last character of the string 312 is ‘C’, thus the automaton M_{HTTP} performs a transition 310 on C from the state q₄ 304 to the state q₅ 305. Now, all the characters of the string 312 are read and examined and the current state q₅ is the final state. Therefore the character string “OSRSRCOSRC” 312 is accordant with the regular expression E_{HTTP}=(O(SR)*C)* and the automation M_{HTTP} accepts the character string 312.

The automation M_{HTTP} is just one example of an automaton that can be utilized in the method accordant with the invention. An appropriate automaton is used in the third method step.

FIG. 4 shows the main method steps. In the first step 401 the type of a transaction is identified. This transaction is related to at least one message transmitted in a communication network during a session. In addition to the said session, the method is able to handle other simultaneous sessions. Usually, a transaction type can be identified without reading any message related to the transaction. If needed, a sender of a message can write a transaction type in the message, when the method may read the transaction type from the message. This way the transactions types can be classified very precisely. In any case, the transaction type is mapped to a certain token belonging to an input alphabet of an automaton. The automaton is preferably a deterministic finite-state automaton that recognises the character strings accordant with a certain regular expression. In the second step 402 the token is input into the automaton that responds in some way. The response may be, for example, a rule that is usable for the token in the current state of the automaton. In the third step 403 a set of predefined tasks is performed. The said set is selected according to the response of the automaton.

The method can be utilized, for example, to analyse the operation of a service providing HTML pages. The analysis is performed by using an automaton M_{A}. Service requests and responses of the automaton M_{A} are divided into two categories. The first category comprises the service requests addressed to HTML pages of a client. Those service requests are marked with S1 and the corresponsive responses are marked with R1. The second category comprises the service requests addressed to other HTML pages, which are reachable through the links of the HTML pages of the client. This is a typical situation when the client has placed banners on the HTML pages. Clicking of any banner of the HTML pages results in a service request that is marked with S2. The corresponsive response is marked with R2.

The automaton M_{A} accepts character strings that are accordant with the regular expression EA=(O(S1R1)*(S1R1 U S2R2)*C)*.

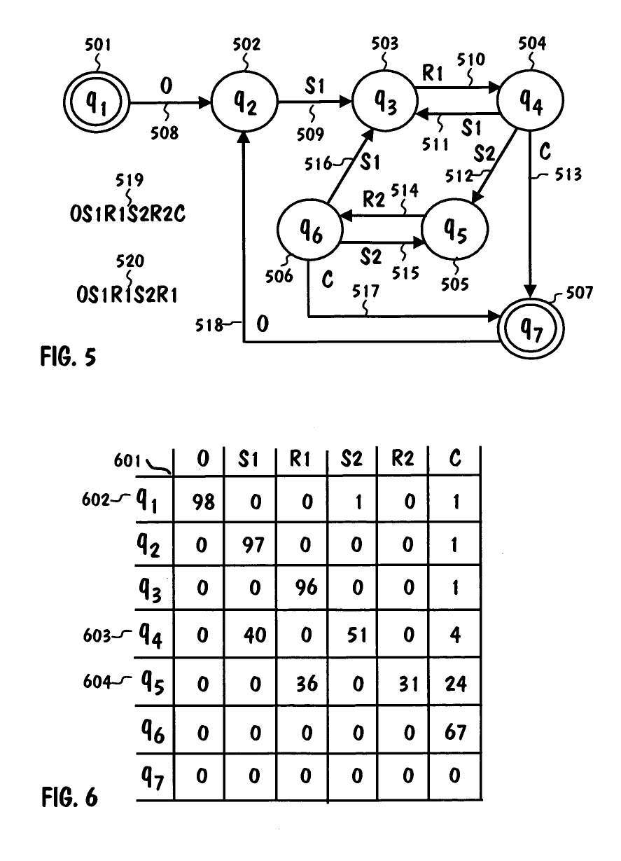

FIG. 5 shows the automaton M_{A} as a transition graph. There are seven states 501-507 and eleven transitions 508-518. First, we may suppose that the automaton obtains a character string “OS1R1S2R2C” 519 as an input. In this case, and end-user has visited on HTML pages and clicked one banner placed on the said pages. The first token of the string 519 is ‘O’, thus the automaton performs a transition 508 on O from the state q₁ 501 to the state q₂ 502. The automaton handles the rest of the tokens of the string 519 and performs transitions 509, 510, 512, 514, and 517. The last transition 517 results in the state q₇ 507, which is the final state. Therefore the automaton accepts the character string 519. Then we may suppose that the automaton obtains a character string “OS1R1S2R1C” 520 as an input. When the automaton has handled the token S2 belonging to the string 520, the current state is the state q₅ 505. Now, the only token that would result in a transition from the state q₅ 505 is R2. Because the next token is R1, no transition can be performed. The state q₅ 505 is a non-final state; therefore the automaton rejects the character string 520. By means of the automaton M_{A}, how many times the operation of the service providing HTML pages has ended successfully can be counted. This requires that the final state q₇ 507 contains a counter whose value is increased by one each time the automaton accepts a character string. In addition, if the initial state q₁ 501 contains another counter whose value is increased by one per transaction type identified, the percent of the successful transactions can be counted.

Generally speaking, a counter is mapped to some rule of an automaton. The counters can be organized to an operation table describing in detail the operation of a service within different transactions. The operation table is formed so that its first dimension is composed of the states of an automaton and its second dimension is composed of the input alphabet of the automaton, and each element of the operation table contains a counter.

FIG. 6 shows the operation table related to the automaton M_{A}. The operation table 601 of the automaton M_{A} is formed so that the rows of the operation table are composed of the states of the automaton M_{A} and the columns of the operation table are composed of the tokens belonging to the alphabet of the automaton M_{A}. Let us suppose that the operation table 601 is filled with numbers related to one hundred transactions. Those transactions are initiated by one or more end-users and each transaction type identified is mapped to a certain token. As can be seen on the first row 602 of the table, ninety-eight times a token was correct in the state q₁ and two times a token was incorrect. The fourth row 603 of the operation table indicates that in fifty-one transactions an end-user has clicked a banner. The fifth row 604 indicates that only in thirty-one transactions an end-user has received a response. Thus, there is obviously something wrong with the banner. This is just one example, how an automaton and its counter values can be utilized when analysing the use of a service.

As shown above, the counters can be organized to an operation table. Alternatively, the counters can be organized to counter sets so that there is a mapping between a certain state of an automaton and a certain counter set. We use the automaton M_{A} as an example to illustrate counter sets. The definition of the automaton M_{A} is the following:

$${M}_{A} = ( \{ {q}_{1} , {q}_{2} , {q}_{3} , {q}_{4} , {q}_{5} , {q}_{6} , {q}_{7} \} \{ O , S1 , R1 , S2 , R2 , C \} , \{ {q}_{1} O \to {q}_{2} , {q}_{2} S1 \to {q}_{3} , {q}_{3} R1 \to {q}_{4} , {q}_{4} S2 \to {q}_{5} , {q}_{4} S1 \to {q}_{3} , {q}_{4} C \to {q}_{7} , {q}_{5} R2 \to {q}_{6} , {q}_{6} S1 \to {q}_{3} , {q}_{6} S2 \to {q}_{5} , {q}_{6} C \to {q}_{7} , {q}_{7} O \to {q}_{2} \} , {q}_{1} , \{ {q}_{7} \} ) ,$$

According to the rule set of the automaton M_{A}, the states q₁, q₂, q₃, q₅, and q₇ are such states that one transition is possible. Therefore each of the said states is related to a counter set composed of one counter.

According to the rule set of the automaton M_{A}, the states q₄ and q₆ are such states that three transitions are possible. Therefore each of the said states is related to a counter set composed of three counters.

The definition of an automaton can be utilized in many ways when naming counters and forming either counter sets or an operation table. The counter values can be used as statistical data when analysing the operation of a service.

Generally speaking, when a certain rule of an automaton is obeyed, at least one predefined task mapped to the said rule is performed. A set of predefined tasks may contain a task that changes a value of the counter. Then it is possible that a certain rule is obeyed only if the value of the counter meets a condition related to the rule.

Increasing a counter value is one example of a predefined task. Let us define automaton M′_{HTTP} to give other examples of predefined tasks. The definition is the same as the definition of the automaton M_{HTTP} described above, except that the rule set P′ of the automaton M′_{HTTP} differs from the rule set of the automaton M_{HTTP}. The rule set P′ is composed of rules q₁O→q₂, q₂S→q₃, q₃R→q₄, q₄C→q₅, q₄S→q₃, and q₅O→q₂ and a condition. The condition determines that a rule is obeyed only if a token (O, S, R, or C) is related to a unique communication message. The use of automaton M′_{HTTP} requires that messages contain a sequence number and the states of an automaton are related to counters that store the highest sequence numbers detected. If a received message contains a sequence number that exceeds the highest sequence number detected in a current state of an automaton, the said message is charged. The idea is that each unique message is charged only once. This makes billing more fair-minded when messages must be retransmitted due to communication network problems. The condition can be mapped, for example, to the rules q₂S→q₃, and q₄S→q₃ in which an end-user initiates a service request. Each service request can be charged in a different way. The condition may also be mapped to the rule q₃R→q₄, when the end-user is charged for the messages sent by a service. Thus, predefined tasks within the automaton M′_{HTTP} concern charging.

The transaction manager is a system using the method described in FIG. 4. 1. It can be placed in many kinds of equipment through which one or more automatons are usable.

For example, the transaction manager can be placed in a server cluster handling messages in a communication network. If the server cluster contains a master server through which all messages and transactions are received, the transactions manager is preferably placed in the master server. Then the master server is responsible for automatons of the transaction manager and the master server updates the states of the automatons when it handles messages.

If there is no master server, i.e. the members of a server cluster are equal, the members share automatons and update the automatons in cooperation. This can be performed so that each time a member identifies the type of a transaction, it sends the corresponsive token to the other members of the server cluster. Then the said members update their copy of the automatons.

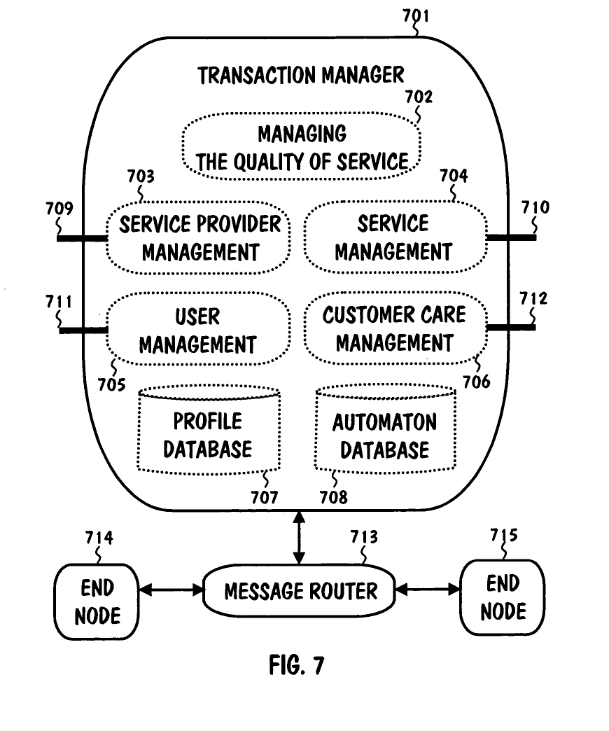

FIG. 7 shows an example of the transaction manager connected to a message router. The transaction manager 701 contains: logic for its five main functions 702-706, a profile database 707, an automaton database 708, and user interfaces 709-712. The description of the main functions 702-706 can be in found in PCT/FI02/00270. The profiles stored in the profile data-base 707 include predefined tasks that are mapped to the states of the automatons stored in the automaton database 708. The user interface 709 of the service provider management is intended for a service operator, the user interface 710 of the service management is intended for service providers, the user interface 711 of the user management is intended for end-users, and the user interface 712 of the customer care management is intended for customer care personnel. Through these user interfaces the service operator, service providers, end-users, and customer care personnel can access and modify their 1) profiles stored in the profile database and/or 2) automatons stored in the automaton database. The message router 713 communicates with an end-user 714 and a service 715. In addition to short messages, the message router may route IP packets and other types of messages. The transaction manager receives and sends messages via the message router 713 and handles the messages sent by the end-user and/or the service using the automatons of the automaton database.

1. A system for managing transactions belonging to at least one session, wherein the system is adapted to:
identify the type of a transaction, said transaction being related to at least one message transmitted in a communication network during a session,
input a token into an automaton, said token being mapped to the type of the transaction and said token belonging to input alphabets of the automaton, and according to a response of the automaton,
perform a set of predefined tasks resulting in at least a transition from a current state of the automaton to another state of the automaton when a rule of the automaton is usable for said token in the current state of the automaton.

2. The system as described in claim 1, wherein the automaton is a deterministic finite-state automaton.

3. The system as described in claim 1, wherein the automaton accepts a character string including the token when the other state is a finite state of the automaton.

4. The system as described in claim 1, wherein a counter is mapped to the rule usable.

5. The system as described in claim 4, wherein the set of predefined tasks contains a task that changes a value of the counter.

6. The system as described in claim 5, wherein the rule is obeyed when the value of the counter meets a condition related to the rule.

7. The system as described in claim 4, wherein said counter belongs to an operation table which describes an operation of some service used via the communication network, a first dimension of the operation table being composed of the states of the automaton and a second dimension of the operation table being composed of the input alphabets of the automaton, and each element of the operation table containing a counter.

8. The system as described in claim 4, wherein said counter and a set of counters mapped to other rules of the automaton are organized in counter sets so that there is a mapping between a certain state of the automaton and a certain counter set.

9. The system as described in claim 1, wherein the type of the transaction is read from a message.

10. The system as described in claim 1, wherein the type of the transaction is one of the following types: 1) a client opens a TCP connection to a server, 2) the client sends a service request to the server, 3) the server sends a response to the client, or 4) the client closes the TCP connection.

11. The system as described in claim 1, wherein the automaton belongs to an automaton set placed in equipment, the said automaton set being usable through the equipment.

12. The system as described in claim 11, wherein the automaton set is changeable through at least one user interface.

13. The system as described in claim 11, wherein when the equipment containing a master server that receives all transactions, the master server is responsible for the automaton and updates states of the automaton.

14. The system as described in claim 11, wherein when the equipment is composed of equal members, said members share the automaton and update the automaton in cooperation.

15. The system as described in claim 1, wherein the system is further adapted to send and receive messages through a message router providing messaging connectivity, said messages including at least one message related to the transaction.

16. A method for managing transactions belonging to at least one session, the method comprising the steps of
identifying the type of a transaction, said transaction being related to at least one message transmitted in a communication network during a session,
inputting a token into an automaton, said token being mapped to the type of the transaction and said token belonging to input alphabets of the automaton, and according to a response of the automaton,
performing a set of predefined tasks resulting in at least a transition from a current state of the automaton to another state of the automaton when a rule of the automaton is usable for said token in the current state of the automaton.

17. The method as described in claim 16, wherein the automaton is a deterministic finite-state automaton.

18. The method as described in claim 16, wherein the automaton accepts a character string including the token when the other state is a finite state of the automaton.

19. The method as described in claim 16, wherein a counter is mapped to the usable rule.

20. The method as described in claim 19, wherein the set of predefined tasks contains a task which changes a value of the counter.

21. The method as described in claim 20, wherein the rule is obeyed when the value of the counter meets a condition related to the rule.

22. The method as described in claim 19, wherein said counter belongs to an operation table which describes an operation of some service used via the communication network, a first dimension of the operation table being composed of the states of the automaton and a second dimension of the operation table being composed of the input alphabets of the automaton, and each element of the operation table containing a counter.

23. The method as described in claim 19, wherein said counter and a set of counters mapped to other rules of the automaton are organized to counter sets so that there is a mapping between a certain state of the automaton and a certain counter set.

24. The method as described in claim 16, wherein the type of the transaction is read from a message.

25. The method as described in claim 16, wherein the type of the transaction is one of the following types: 1) a client opens a TCP connection to a server, 2) the client sends a service request to the server, 3) the server sends a response to the client, or 4) the client closes the TCP connection.
